(19) United States
(12) Patent Application Publication
(10) Pub. No.: US 2007/0161119 A1
(43) Pub. Date: Jul. 12, 2007

(54) Methods for fabricating chemical arrays

(76) Inventors: Bill James Peck, Mountain View, CA (US); Eric M. Leproust, San Jose, CA (US); Heather Brummel McCuen, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/332,190

(22) Filed: Jan. 12, 2006

(51) Int. Cl. G01N 1/10

(52) U.S. Cl. 436/180

(57) ABSTRACT

Methods for fabricating chemical arrays are provided. Aspects of the invention include methods for providing solid activator in feature locations of a substrate surface. Aspects of the invention also include substrates having solid activator present in feature locations thereof, arrays produced from the substrates, methods for use of the arrays and kits that include the arrays.

### BACKGROUND

Arrays of chemical binding agents, such as nucleic acids and polypeptides, have become an increasingly important tool in the biotechnology industry and related fields. These chemical (i.e., binding agent or ligand) arrays, in which a plurality of chemical binding agents are positioned on a solid support surface in the form of an array or pattern, find use in a variety of applications, including gene expression analysis, drug screening, nucleic acid sequencing, mutation analysis, comparative genome hybridization, location analysis and the like.

Where the chemical binding agents of the arrays are polymeric agents, e.g., as is the case with nucleic acid and polypeptide arrays, there are two main ways of producing such arrays, i.e., via in-situ synthesis in which the polymeric ligand is grown on the surface of the substrate in a step-wise fashion and via deposition of the full ligand, e.g., a presynthesized nucleic acid/polypeptide, cDNA fragment, etc., onto the surface of the array.

Representative in situ synthesis methods include those described in U.S. Pat. No. 5,449,754 for synthesizing peptide arrays, as well as WO 98/41531 and the references cited therein for synthesizing polynucleotides (specifically, DNA) using phosphoramidite or other chemistries. Such in situ synthesis methods can be regarded as iterating the sequence of depositing droplets of: (a) a protected monomer onto predetermined locations on a substrate to link with either a suitably activated substrate surface (or with previously deposited deprotected monomer); (b) deprotecting the deposited monomer so that it can react with a subsequently deposited protected monomer; and (c) depositing another protected monomer for linking. Different monomers may be deposited at different regions on the substrate during any one cycle so that the different regions of the completed array will carry the different biopolymer sequences as desired in the completed array. With respect to nucleic acid array in situ production, phosphoramidite nucleoside monomers are generally used. In order for the phosphoramidite group to link to a hydroxyl of a previously deposited polynucleotide monomer, it is first activated in many applications, e.g., by using a weak acid such as tetrazole. One or more intermediate further steps may be required in each iteration, such as oxidation and washing steps.

In the in situ manufacture of chemical arrays, it can be desirable to produce arrays in which the feature density is as high as possible, e.g., so that as many different targets can be screened on the same array. Accordingly, it is desirable to employ a protocol that provides for tight control over feature size during fabrication.

### SUMMARY

Aspects of the invention include methods for positioning a solid activator in feature locations of a substrate surface. In the subject methods a substrate surface having feature locations is contacted with a fluid composition of the activator reagent. The fluid composition is then removed from the surface in a manner sufficient to produce solid activator in the feature locations but substantially no activator in the intervening inter-feature regions of the substrate. In certain embodiments, ligands are then produced on the functionalized surface, e.g., by contacting the resultant functionalized surface with ligands or monomeric precursors thereof. Aspects of the invention also include arrays produced from the functionalized substrates, methods for use of the arrays and kits that include the arrays.

### BRIEF DESCRIPTION OF THE FIGURES

FIG. 1 illustrates a substrate carrying an array, such as may be fabricated by methods according to aspects of the present invention;

FIG. 2 is an enlarged view of a portion of FIG. 1 showing multiple spots (i.e. features); and

FIG. 3 is an enlarged illustration of a portion of the substrate in FIG. 2.

FIG. 4 is an enlarged cross-section illustrating a sequence of events in a method according to one aspect of the present invention during formation of one feature of an array.

FIG. 5 is a schematic view of an in situ array fabrication device in accordance with an embodiment the present invention.

FIG. 6 provides a depiction of a substrate surface produced according to an aspect of the invention.

### DEFINITIONS

The term “polymer” means any compound that is made up of two or more monomeric units covalently bonded to each other, where the monomeric units may be the same or different, such that the polymer may be a homopolymer or a heteropolymer. Representative polymers include peptides, polysaccharides, nucleic acids and the like, where the polymers may be naturally occurring or synthetic.

The term “peptide” as used herein refers to any polymer compound produced by amide formation between an α-carboxyl group of one amino acid and an α-amino group of another group.

The term “oligopeptide” as used herein refers to peptides with fewer than about 10 to 20 residues, i.e., amino acid monomeric units.

The term “polypeptide” as used herein refers to peptides with more than 10 to 20 residues.

The term “protein” as used herein refers to polypeptides of specific sequence of more than about 50 residues.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single-stranded nucleotide multimers of from about 10 up to about 200 nucleotides in length, e.g., from about 25 to about 200 nt, including from about 50 to about 175 nt, e.g. 150 nt in length

The term “polynucleotide” as used herein refers to single- or double-stranded polymers composed of nucleotide monomers of generally greater than about 100 nucleotides in length.

The term “functionalization” as used herein relates to modification of a solid substrate to provide a plurality of functional groups on the substrate surface. By a “functionalized surface” as used herein is meant a substrate surface that has been modified so that a plurality of functional groups are present thereon.

The term “array” encompasses the term “microarray” and refers to an ordered array presented for binding to ligands such as polymers, polynucleotides, peptide nucleic acids and the like.

The terms “reactive site”, “reactive functional group” or “reactive group” refer to moieties on a monomer, polymer or substrate surface that may be used as the starting point in a synthetic organic process. This is contrasted to “inert” hydrophilic groups that could also be present on a substrate surface, e.g., hydrophilic sites associated with polyethylene glycol, a polyamide or the like.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other polynucleotides which are C-glycosides of a purine or pyrimidine base, polypeptides (proteins), polysaccharides (starches, or polysugars), and other chemical entities that contain repeating units of like chemical structure. In the practice of the instant invention, oligomers will generally comprise about 2-50 monomers, preferably about 2-20, more preferably about 3-10 monomers.

The term “monomer” as used herein refers to a chemical entity that can be covalently linked to one or more other such entities to form a polymer. Of particular interest to the present application are nucleotide “monomers” that have first and second sites (e.g., 5′ and 3′ sites) suitable for binding to other like monomers by means of standard chemical reactions (e.g., nucleophilic substitution), and a diverse element which distinguishes a particular monomer from a different monomer of the same type (e.g., a nucleotide base, etc.). In the art synthesis of nucleic acids of this type utilizes an initial substrate-bound monomer that is generally used as a building-block in a multi-step synthesis procedure to form a complete nucleic acid.

The term “ligand” as used herein refers to a moiety that is capable of covalently or otherwise chemically binding a compound of interest. The arrays of solid-supported ligands produced by the methods can be used in screening or separation processes, or the like, to bind a component of interest in a sample. The term “ligand” in the context of the invention may or may not be an “oligomer” as defined above. However, the term “ligand” as used herein may also refer to a compound that is “pre-synthesized” or obtained commercially, and then attached to the substrate.

The term “sample” as used herein relates to a material or mixture of materials, typically, although not necessarily, in fluid form, containing one or more components of interest.

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

As used herein, the term “amino acid” is intended to include not only the L, D- and nonchiral forms of naturally occurring amino acids (alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine), but also modified amino acids, amino acid analogs, and other chemical compounds which can be incorporated in conventional oligopeptide synthesis, e.g., 4-nitrophenylalanine, isoglutamic acid, isoglutamine, ε-nicotinoyl-lysine, isonipecotic acid, tetrahydroisoquinoleic acid, α-aminoisobutyric acid, sarcosine, citrulline, cysteic acid, t-butylglycine, t-butylalanine, phenylglycine, cyclohexylalanine, β-alanine, 4-aminobutyric acid, and the like.

A biomonomer fluid or biopolymer fluid reference a liquid containing either a biomonomer or biopolymer, respectively (typically in solution).

A “phosphoramidite” includes a group of the structure of formula (I) below:

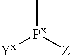

wherein either X is a linking atom such as O or S and may be the same or different; Y is a protecting group such as cyanoethyl; Z may be a halogen (particularly Cl or Br) or a secondary amino group such as morpholino or N (lower alkyl)2 where the alkyl groups are the same or different, preferably N(i-propyl)2. By “lower alkyl” is referenced 1 to 8 C atoms. A nucleoside phosphoramidite has a nucleoside or a nucleoside analog with the sugar ring bonded to the free bond on the X in formula (I). For example, one particular nucleoside phosphoramidite is represented by formula (II) below:

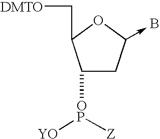

wherein B is a nucleoside base, and DMT is dimethoxytrityl. The O (which may instead be replaced by S) to which DMT is bonded, acts as a second linking group which is protected by the DMT. Protecting groups other than DMT may be used, and their removal during deprotection is known in oligonucleotide synthesis. Other nucleoside phosphoramidites are also known, for example ones in which the phosphoramidite group is bonded to a different location on the 5-membered sugar ring. Phosphoramidites and nucleoside phosphoramidites are described in U.S. Pat. No. 5,902,878, U.S. Pat. No. 5,700,919, U.S. Pat. No. 4,415,732, PCT publication WO 98/41531 and the references cited therein (the disclosures of which are herein incorporated by reference), among others.

A “group” includes both substituted and unsubstituted forms. It will also be appreciated that throughout the present application, words such as “upper”, “lower” and the like are used with reference to a particular orientation of the apparatus with respect to gravity, but it will be understood that other operating orientations of the apparatus or any of its components, with respect to gravity, are possible. Reference to a “droplet” being dispensed from a pulse-jet herein, merely refers to a discrete small quantity of fluid (usually less than about 1000 pL) being dispensed upon a single pulse of the pulse-jet (corresponding to a single activation of an ejector) and does not require any particular shape of this discrete quantity. When a “spot” is referred to, this may reference a dried spot on the substrate resulting from drying of a dispensed droplet, or a wet spot on the substrate resulting from a dispensed droplet which has not yet dried, depending upon the context.

“Fluid” is used herein in its conventional sense to denote either a gaseous or liquid phase.

Use of the singular in reference to an item, includes the possibility that there may be multiple numbers of that item.

The term “protecting group” refers to chemical moieties that, while stable to the reaction conditions, mask or prevent a reactive group from participating in a chemical reaction. Protecting groups may also alter the physical properties such as the solubility of compounds, so as to enable the compounds to participate in a chemical reaction. Examples of protecting groups are known in the art, for example, Greene et al., Protective Groups in Organic Synthesis, 2nd Ed., New York: John Wiley & Sons, 1991.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

An “array,” or “chemical array’ used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. As such, an addressable array includes any one or two or even three-dimensional arrangement of discrete regions (or “features”) bearing particular biopolymer moieties (for example, different polynucleotide sequences) associated with that region and positioned at particular predetermined locations on the substrate (each such location being an “address”). These regions may or may not be separated by intervening spaces. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations. Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

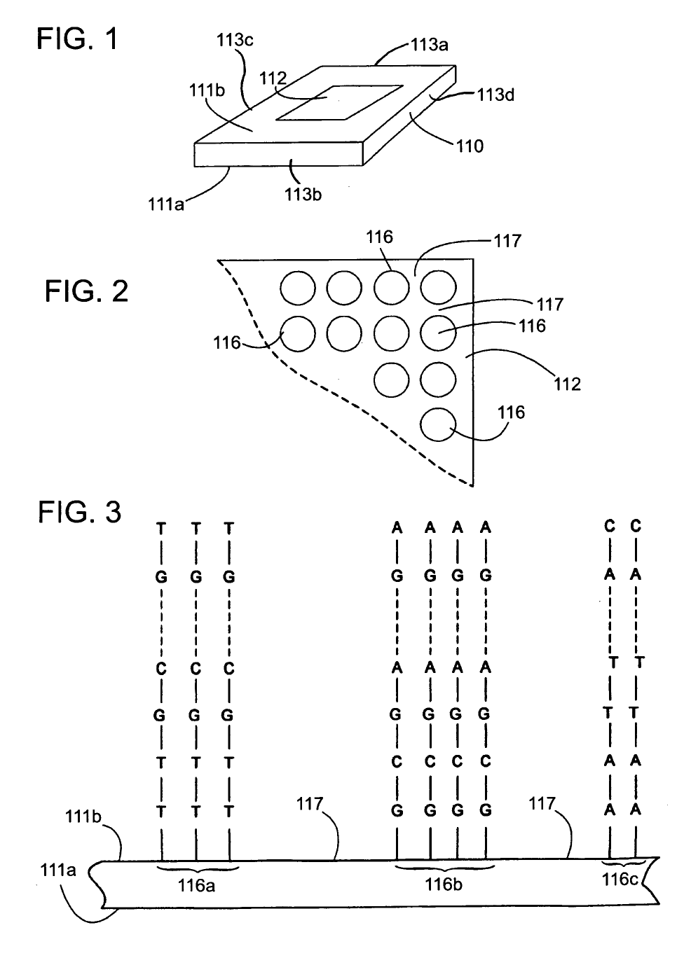

An exemplary chemical array is shown in FIGS. 1-3, where the array shown in this embodiment includes a contiguous planar substrate 110 carrying an array 112 disposed on a rear surface 111b of substrate 110. It will be appreciated though, that more than one array (any of which are the same or different) may be present on rear surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the rear surface 111b, with regions of the rear surface 111b adjacent the opposed sides 113c, 113d and leading end 113a and trailing end 113b of slide 110, not being covered by any array 112. A front surface 111a of the slide 110 does not carry any arrays 112. Array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of biopolymers, e.g., in the form of polynucleotides. As mentioned above, all of the features 116 may be different, or some or all could be the same. The interfeature areas 117 could be of various sizes and configurations. Each feature carries a predetermined biopolymer such as a predetermined polynucleotide (which includes the possibility of mixtures of polynucleotides). It will be understood that there may be a linker molecule (not shown) of any known types between the rear surface 111b and the first nucleotide.

Substrate 110 may carry on front surface 111a, an identification code, e.g., in the form of bar code (not shown) or the like printed on a substrate in the form of a paper label attached by adhesive or any convenient means. The identification code contains information relating to array 112, where such information may include, but is not limited to, an identification of array 112, i.e., layout information relating to the array(s), etc. The substrate may be porous or non-porous. The substrate may have a planar or non-planar surface.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

An array “assembly” includes a substrate and at least one chemical array, e.g., on a surface thereof. Array assemblies may include one or more chemical arrays present on a surface of a device that includes a pedestal supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

“Hybridizing” and “binding”, with respect to polynucleotides, are used interchangeably.

The term “substrate” as used herein refers to a surface upon which marker molecules or probes, e.g., an array, may be adhered. Glass slides are the most common substrate for biochips, although fused silica, silicon, plastic and other materials are also suitable.

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

A “web” references a long continuous piece of substrate material having a length greater than a width. For example, the web length to width ratio may be at least 5/1, 10/1, 50/1, 100/1, 200/1, or 500/1, or even at least 1000/1.

“Flexible” with reference to a substrate or substrate web, references that the substrate can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C.

“Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1 M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions sets forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

“Contacting” means to bring or put together. As such, a first item is contacted with a second item when the two items are brought or put together, e.g., by touching them to each other.

“Depositing” means to position (i.e., place) an item at a location- or otherwise cause an item to be so positioned or placed at a location. Depositing includes contacting one item with another. Depositing may be manual or automatic, e.g., “depositing” an item at a location may be accomplished by automated robotic devices. As used herein, “depositing a solid activator” at a location encompasses depositing a fluid composition comprising activator at a location and removing fluid from the composition so that solid activator remains.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information means transmitting the data representing that information as signals (e.g., electrical, optical, radio signals, and the like) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

An array “package” may be the array plus only a substrate on which the array is deposited, although the package may include other features (such as a housing with a chamber).

A “chamber” references an enclosed volume (although a chamber may be accessible through one or more ports). It will also be appreciated that throughout the present application, that words such as “top,” “upper,” and “lower” are used in a relative sense only.

It will also be appreciated that throughout the present application, that words such as “cover”, “base” “front”, “back”, “top”, are used in a relative sense only. The word “above” used to describe the substrate and/or flow cell is meant with respect to the horizontal plane of the environment, e.g., the room, in which the substrate and/or flow cell is present, e.g., the ground or floor of such a room.

### DETAILED DESCRIPTION

Methods of fabricating chemical arrays are provided. Aspects of the invention include methods for positioning an activator, (e.g., a reagent for activitating a phosphoramidite group so that it can covalently bond to a functionality, e.g., hydroxyl group) in feature locations of a substrate surface. Aspects of the invention include contacting a substrate surface having feature locations with a fluid composition of the activator reagent. The fluid component of the composition is then removed from the surface in a manner sufficient to produce solid activator in the feature locations but substantially no activator in the intervening inter-feature regions of the substrate. In certain embodiments, ligands are then produced on the functionalized surface, e.g., by contacting the resultant functionalized surface with ligands or monomeric precursors thereof. Aspects of the invention also include surfaces comprising solid activator at feature locations on the surface, arrays produced from the functionalized substrates, methods for use of the arrays and kits that include the arrays.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As summarized above, the invention provides methods for fabricating chemical arrays. A feature of embodiments of the subject invention is that an activator is employed at some point during the chemical array production protocol, e.g., in the attachment of a biopolymeric ligand or precursor thereof to a substrate surface. In representative embodiments, the methods are methods for fabricating biopolymer arrays on a substrate using an in situ fabrication protocol, e.g., where the array is fabricated using a pulse-jet head. In representative embodiments, the in situ protocols in which the subject methods find use are methods of polymeric synthesis. Embodiments of such methods include repeated sequential contact of an activated monomer to a terminal functional moiety of a growing polymeric ligand under conditions such that the activated monomer covalently bonds to terminal functional moiety. As a result, surface bound ligands of desired monomeric residue sequence are produced. As reviewed above, in situ protocols for the use in the synthesis of polymeric ligand arrays are known in the art, being described in U.S. Pat. Nos. 6,306,599; and 6,300,137 among other locations.

Aspects of the invention include positioning an activator in feature locations of a substrate using a protocol that provides for efficient deposition within feature locations, but substantially little, if any, deposition in inter-feature regions. In other words, a protocol is employed to place activator in feature locations of the surface, where the protocol is one that results in little, if any, activator being deposited in inter-feature regions on the surface. An aspect of the invention is that the activator is provided in a fluid activator composition, from which fluid is removed to provide solid activator at the feature location.

In one embodiment, a substrate surface has one or more feature locations separated by inter-feature regions. In certain aspects, the feature locations have a different surface energy from the inter-feature regions. In representative embodiments, the feature locations are wettable by a solvent of a fluid activator composition, while the inter-feature regions are not, e.g., where the feature locations are lyophilic and the inter-feature regions are lyophobic.

The solid support surface can include a plurality of feature locations, i.e., 2 or more, such as about 10 or more, including about 50 or more, etc., and in certain embodiments, the surface includes 100 or more, 1000 or more, 5000 or more, 10,000 or more, 25,000 or more feature locations. The density of the feature locations in such embodiments may vary, and may be at least about 10/cm², such as at least about 50/cm², including at least about 100/cm² e.g., at last about 400/cm², 1000/cm² or denser. The array of feature locations may be in a precise pattern, such as a plurality of spots in an ordered pattern of columns and rows.

The initial substrate employed in the subject invention may be made of any convenient material that has a plurality of reactive hydrophilic sites on its surface, or that can be treated or coated so as to have a plurality of such sites on its surface. Suitable materials include, but are not limited to, glass, controlled pore glass (CPG″), quartz, silicon or silicon covered with silicon dioxide, ceramics, supports typically used for solid phase chemical synthesis, e.g., cross-linked polymeric materials (e.g., divinylbenzene styrene-based polymers), agarose (e.g., SEPHAROSE™), dextran (e.g., SEPHADEX™), non-porous and porous substrates, cellulosic polymers, polyacrylamides, and the like. The supports may be obtained commercially and used as is, or they may be treated or coated prior to use. The substrate surfaces are typically planar, although planarity is not required and the surfaces can be of any geometry suitable for contact with silanizing reagents used in formation of an array.

In certain embodiments, the solid support whose surface displays the one or more feature locations is a solid support that has a surface which has been chemically modified (e.g., functionalized) with a surface energy modification reagent. Accordingly, in a representative embodiment, the surface of a solid support (e.g., a substrate) is first functionalized by being contacted with a surface energy modification reagent, such as a silane-derivatizing composition that contains one or more types of silanes, which functionalized surface is then modified, e.g., via pulse-jet deposition of biopolymers or precursor residues thereof, so as to produce a surface with at least one feature location. In representative embodiments, the surface of the solid support is derivatized by contacting it with a silane-derivatizing composition of one or more silanizing reagents. In certain embodiments of interest, the derivatizing composition may include two or more types of silanes, which may be the same or different from one another. For instance, the two or more silanes may differ with respect to their leaving group substituents, which may include, but are not limited to: halogens, chloro, alkoxy, aryloxy moieties, lower alkyl, e.g., methyl, ethyl, isopropyl, n-propyl, t-butyl moieties, and the like. In certain embodiments where a mixture of silanes make up the derivatizing composition, the first silane is a derivatizing agent that reduces surface energy, while the second silane provides a desired functionality.

For instance, the second silane may include a functional group that can bind directly to an additional molecular species of interest, e.g., biopolymer precursor residue, such as a phosphoramidite, or a modifiable group that can be converted to a functional group under conditions that do not substantially affect any other chemical species that are present on the substrate surface. The functional group may be any group that facilitates the binding of a ligand to the substrate such as, but not limited hereto a hydroxyl, carboxyl, amino, or the like, or it may be a modifiable group such an olefinic moiety, e.g., a terminal CH═CH₂ group, which can readily be converted to a reactive hydroxyl group by hydroboration and oxidation using procedures known in the art. Additional functional groups of interest include, but are not limited to, those described in U.S. Pat. Nos. 6,660,338; 6,444,268; 6,387,631; 6,319,674; 6,291,183; and 6,258,454. Methods for silanizing a solid support include those described in co-pending U.S. application Ser. No. 11/050,139. See also U.S. Pat. No. 6,258,454 for a further description of the general process of derivatizing a surface.

Following provision of the desired solid support having one or more feature locations separated by inter-feature regions(s), as described above, the resultant substrate can be employed in the fabrication of solid supports having chemical ligands immobilized on a surface thereof, e.g., such as ligand arrays. In fabricating arrays according to the present invention, an activator reagent is positioned in the feature locations of the substrate surface. As reviewed above, the activator reagent is positioned in the feature location(s) in a manner such that activator (e.g., in solid form) substantially if not completely covers each of the feature locations but little, if any, activator is present in the non-feature locations.

In one aspect, at least a portion of, if not all of, the substrate surface is contacted with a fluid composition comprising the activator. A “fluid composition comprising the activator” refers to a liquid that includes an amount of activator reagent, where the concentration of activator reagent in the fluid is sufficient to provide for the desired residue, e.g., phosphoramidite, activation during the phosphoramidite synthesis protocol. The particular activator reagent depends on the particular biopolymer being to be fabricated. For example, in the case of phosphoramidites, suitable activators are known and include, but are not limited to: tetrazole, S-ethyl tetrazole, dicyanoimidazole (“DCI”), or benzimidazolium triflate. Likewise, a suitable activator in the case of amino acids for polypeptide synthesis is dicyclohexylcarbodiimide (DCC).

As to solvents for the activator, of interest are low boiling point solvents e.g., having a boiling point that does not exceed about 110° C., such as a boiling point that does not exceed about 80° C., where any low boiling point solvent could be used provided it is otherwise compatible with the chemistry being employed. In the case of phosphoramidites a non-protic low boiling point solvent could be used, for example, acetonitrile, dioxane, toluene, ethylacetate, acetone, tetrahydrofuran, and the like. In certain embodiments, the fluid composition further includes an amount of a higher boiling point co-solvent, e.g., in an amount sufficient to keep the activator on the feature surface during evaporation, as described below. The ratio of this co-solvent to solvent, when present, may range from about 1:100 to about 100:1, such as from about 1:10 to about 10:1. By higher boiling point solvent is meant a solvent that has a boiling point that is at least about 110° C., such as at least about 10° C. higher than the low boiling point solvent, where the boiling point of the co-solvent ranges, in representative embodiments, from about 110° C. to about 300° C., such as from about 120° C. to about 200° C. Representative co-solvents of interest include, but are not limited to: propylene carbonate, di-ethyl carbonate, di-methyl carbonate, adiponitril, ethylene sulfoxide, DMSO and the like.

In contacting the surface of feature locations with the fluid composition of activator, the surface may be contacted in a manner such that the fluid composition contacts only a portion of the feature locations or all of the feature locations on the surface. However, one aspect of the invention is that at least a portion of the inter-feature region(s) on the surface is also contacted with the fluid composition, such that the fluid composition initially contacts at least some of the inter-feature regions of the surface. Contact of the fluid composition with the surface may be achieved using an convenient protocol, such as by dispensing the fluid from a pulse-jet, e.g., using multiple drops to provide for the desired multi-feature contact, by flooding the surface, e.g., in a flow cell, as is known in the art, etc. Contact of the fluid activator composition with the surface is maintained in representative embodiments for a period of time ranging from about 0.1 μs to about 10 s, such as from about 1 μs to about 1 s.

In one aspect, the fluid activator composition is removed from the substrate surface. A feature of this fluid removal step is that the fluid composition is removed from the substrate surface in a manner sufficient to produce solid activator in the plurality of feature locations and substantially no activator in said intervening inter-feature regions. By substantially no activator is meant that the amount of activator present in inter-feature regions in terms of mass/area is less than 10%, such as less than 5%, including less than 1%, e.g., less than 0.5%, less than 0.1% or less than that present in feature locations. As such, in certain embodiments an inter-feature region which is surrounded by four features, e.g., as shown in FIG. 2, the inter-feature region has an amount of activator in terms of mass/area that is less than about 10%, such as less than about 5%, including less than about 1%, e.g., less than about 0.5%, less than about 0.1% or less than that present in any of the surrounding feature locations.

In certain embodiments, removal of the fluid activator composition includes bulk fluid removal followed by solvent evaporation. In certain embodiments, bulk fluid removal includes draining the fluid activator composition from the fluid surface at a controlled, predetermined rate which provides droplets of the fluid composition at the features of the surface but for little, if any, of the fluid composition at the inter-feature regions of the surface. In certain embodiments, the rate at which the fluid composition is removed from the surface ranges from about 1 mm/s to about 30 cm/s, such as from about 1 cm/s to about 10 cm/s.

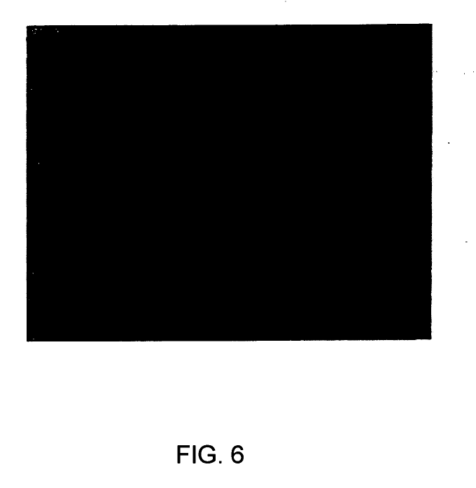

In one aspect, bulk fluid removal, e.g., as described above, results in the production of a substrate surface which has droplets of fluid activator composition covering the feature locations, but no fluid activator composition in the inter-feature regions, i.e., the presence of droplets of fluid activator composition on the feature locations of the substrate. The volume of fluid in a given fluid activator composition located at a given feature location following bulk fluid removal, e.g., as described above, may vary, e.g., depending on the nature of the particular fluid composition and the size of the feature, but in certain embodiments may range from about 0.1 pL to about 100 pL, such as from about 0.5 pL to about 20 pL. A representative image of droplets of fluid activator composition on a surface produced according to the above described method is shown in FIG. 6.

As reviewed above, in one aspect the fluid activator composition includes a low-boiling point solvent. As such, following bulk fluid removal, the substrate surface is maintained under conditions sufficient for the solvent to evaporate to produce a solid activator composition within the features of the surface. Conditions under which the surface is maintained in this evaporation portion of the process may vary, but in representative embodiments may be at temperatures ranging from about 0° to about 80° C., such as from about 25° to about 40° C. To enhance the rate of evaporation of the solvent, a suitable gas, e.g., air, nitrogen, helium, argon, etc., may be circulated above the surface, e.g., by exposing the surface with a pressurized source of the gas, etc.

The above protocol results in the production of a surface having solid activator reagent present in at least some of, if not all of, the features on the surface. Furthermore, the inter-feature regions of the surface are substantially, if not completely, devoid of solid activator. Because of the particular protocol employed, the features are substantially if not completely covered with solid activator, while the inter-feature regions are free of any solid activator.

The resultant activator-containing surface can be employed in a variety of applications, such as in the fabrication of arrays, e.g., via polymeric ligand deposition where one or more polymeric ligands are contacted with the functionalized surface; or in-situ polymeric ligand synthesis, as described below in greater detail. A feature of the activator-containing surfaces produced according to aspects of the subject invention is that they are particularly suitable for use as substrates in in situ ligand array production.

The in-situ synthesis methods include those described in U.S. Pat. No. 5,449,754 for synthesizing peptide arrays, as well as WO 98/41531 and the references cited therein for synthesizing polynucleotides (specifically, DNA) using phosphoramidite or other chemistry. Further details of in situ methods are provided in U.S. Pat. No. 6,242,266, U.S. Pat. No. 6,232,072, U.S. Pat. No. 6,180,351, U.S. Pat. No. 6,171,797, U.S. Pat. No. 6,323,043, and U.S. patent application Ser. No. 09/302,898 all referenced above.

As reviewed above, such in-situ synthesis methods can be regarded as iterating the sequence of depositing: (a) a protected monomer onto predetermined locations on a substrate to link with either a suitably activated substrate surface, as described above, or with a previously deposited deprotected monomer; (b) deprotecting the deposited monomer so that it can now react with a subsequently deposited protected monomer; and (c) depositing another protected monomer for linking. Different monomers may be deposited at different regions on the substrate during any one cycle so that the different regions of the completed array will carry the different biopolymer sequences as desired in the completed array. One or more intermediate further steps may be required in each iteration, such as oxidation and washing steps.

In such embodiments, a volume of fluid comprising monomer (“fluid monomer”) is deposited on a feature location that includes solid activator, e.g., provided as described above. In one aspect, the deposited fluid monomer typically mixes with the activator previously deposited on the surface. The mixing action may conveniently be generated by the impact of the droplet containing the monomer with dried activator at the feature.

Upon contact with the fluid monomer, the activator activates the first linking group of the monomer present in the fluid monomer, e.g., a phosphoramidite group as found in monomers employed in in situ nucleic acid production, such that the activated group will then link with a substrate bound moiety, e.g., a hydroxyl moiety (e.g., that is present on a silane-derivatized surface if it is the first residue or on a previously deposited residue), to produce a covalent bond, such that the monomer in the deposited second volume becomes covalently bound to the substrate surface, either directly or through one or more intervening monomeric residues of a polymeric ligand.

The above steps of activator deposition and fluid monomer deposition can be repeated at each desired feature region on the array until the desired biopolymer has been synthesized. It shall be understood however, that intermediate oxidation, deprotection, washing and other steps may be performed between cycles, as is well known in the art of synthesizing biopolymers. These cycles may be repeated using different or the same monomers at multiple regions over multiple cycles as required to fabricate the desired array or arrays on a substrate.

In embodiments of the invention, at least two distinct polymers are produced on different feature regions of the substrate surface. By distinct is meant that the two polymers differ from each other in terms of sequence of monomeric units. The number of different polymers that are produced on the substrate surface may vary depending on the desired nature of the array to be produced, e.g., the desired density of polymeric structures. In one aspect, the number of distinct polymers that are produced on the surface of the array is at least about 5, such as at least about 10 and including at least about 100, where the number may be as high as 1,000,000 or higher, but in certain embodiments will not exceed about 500,000 and in certain other embodiments will not exceed about 100,000.

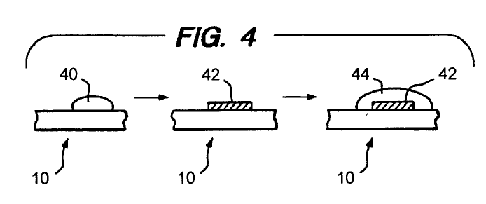

An in situ fabrication protocol according to one embodiment of the invention is depicted in FIG. 4. These figures are not to scale, with some features being exaggerated for clarity. It will be assumed that a suitable functional moiety, e.g., hydroxyl group, is present at least at the location of each feature or region to be formed. The functional moiety may, for example, be present on a nucleoside monomer that has been deposited and deprotected at the location of each feature, such that the functional moiety is available for linking to another activated nucleoside monomer. Alternatively, the functional moiety may be a suitable group previously attached to substrate 10, e.g., in a silane-derivatization protocol, as illustrated above.

FIG. 4 illustrates only one region of an array being fabricated. A droplet 40 of a fluid activator composition comprising a solvent is provided in the feature location according to an aspect of the invention as described above. The solvent of the fluid composition is then allowed to evaporate to form a layer 42 of solid activator in the feature location on substrate 10. Given the volume of a typical droplet, and the solvents which may be used, as discussed herein, this evaporation may take place in less than one second (and may be completed in less than 0.5 or even 0.25 seconds). A droplet 44 of a biomonomer solution, such as a nucleoside phosphoramidite monomer, is then deposited onto the feature location. In certain embodiments, this droplet 44 may cover an area which is greater than or less than that covered by the activator layer 42, as shown in FIG. 4. The solid activator of layer 42 will activate the first linking group of the biomonomer, specifically the phosphoramidite group of a nucleoside monomer, such that the activated group will then link with the surface functional moiety (e.g., a functional group (such as a hydroxyl group) previously attached to substrate 10 or present on a deprotected nucleoside monomer deposited in a previous cycle).

The above steps can be repeated at a feature location or region, such as illustrated in FIG. 4, until the desired biopolymer is synthesized. It will be understood however, that intermediate oxidation, deprotection, washing and other steps may be required between cycles, as is well known in the art of synthesizing biopolymers (such as oligonucleotides). These cycles may be repeated using different or the same biomonomers, at multiple regions over multiple cycles, as required to fabricate the desired array or arrays 12 on substrate 10.

The above protocols of the invention produce chemical, e.g., ligand, arrays that can be employed in a variety of different applications, as described in greater detail below.

Whether the ligands are deposited onto the surface of the array in premade form or produced on the surface in situ by deposition of precursors thereof, a common step to both approaches is the production of two or more ligands on the functionalized surface. A feature of certain embodiments is that two or more different ligands or precursors thereof are deposited (e.g., by pulse-jet deposition) onto discrete regions or domains of the substrate surface.

Also provided are pulse-jet fluid deposition devices configured for use in the subject methods. A number of different array fabrication pulse-jet fluid deposition devices are known in the art, including those described U.S. Pat. Nos. 4,877,745; 5,338,688; 5,449,754; 5,474,796; 5,658,802; 5,700,637; and 5,958,342; 6,284,465 and 6,306,599. In many embodiments, a feature of pulse-jet deposition devices of the present invention is that they include programming that directs them to produce arrays according to the present methods.

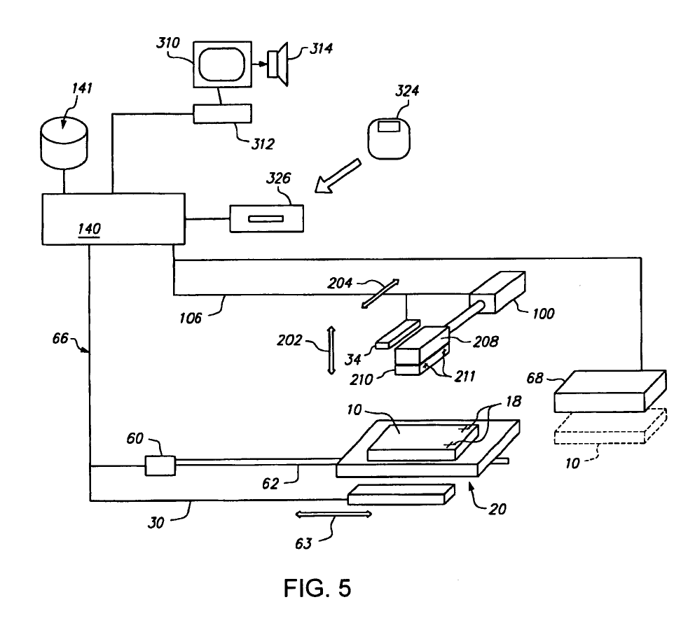

Referring now to FIG. 5, there is shown a system according to one aspect of the invention that includes a substrate station 20 on which can be mounted a substrate 10. Pins 18 or similar means (not shown) can be provided on substrate station 20 by which to approximately align substrate 10 to a position thereon. Substrate station 20 can include a vacuum chuck connected to a suitable vacuum source (not shown) to retain a substrate 10 without exerting too much pressure thereon, since substrate 10 is often made of glass. In one aspect, a flood station (flow cell) 68 is provided which can expose the entire surface of the substrate 10, when positioned in the station 68, as illustrated in broken lines in FIG. 5, to a fluid used in the in situ process, and to which all features must be exposed during each cycle (for example, oxidizer, deprotection agent, and wash buffer), as well as during contact of the surface with a fluid activator composition, as described above.

In one aspect, a pulse-jet head assembly 210 of stacked pulse-jet heads is retained by a head retainer 208. In certain aspects, the pulse-jet head includes pulse-jets which are operatively connected to a reservoir of fluid activator. A positioning system includes a carriage 62 connected to a first transporter 60 controlled by a processor 140, and a second transporter 45 controlled by processor 100. Transporter 60 and carriage 22 are used to execute one axis position of station 20 (and hence mounted substrate 10) facing the dispensing head assembly 210, by moving it in the direction of arrow 63, while transporter 45 is used to provide adjustment of the position of head retainer 208 (and hence head assembly 210) in a direction of axis 204. In this manner, head assembly 210 can be moved line-by-line, by moving the head assembly 210 along a line over a substrate 10 in the direction of axis 204 using transporter 45, while line by line movement of substrate 10 in the direction of axis 63 is provided by transporter 60. Transporter 60 can also move substrate holder 20 to position the substrate 10 beneath flood station 68. Head assembly 210 may also be moved in a vertical direction 202, by another suitable transporter (not shown). It will be appreciated that other configurations could be used. It will also be appreciated that both transporters 60 and 45, or either one of them, with suitable construction, could be used to perform the foregoing motion of the head assembly 210 with respect to the substrate. Thus, when the present invention recites “positioning” one element (such as head assembly 210) in relation to another element (such as one of the stations 20 or substrate 10) it will be understood that any required moving can be accomplished by moving either element or a combination of both of them. The head assembly 210, the positioning systems, and processor 140, together act as the deposition system of the device 100 in accordance with the present invention. An encoder 30 provides data on the exact location of the holder 20, and hence the head assembly position. Any suitable encoder, such as an optical encoder, may be used which provides data on linear position.

Each pulse-jet head of the head assembly is associated with a corresponding set of one or more drop-dispensing orifices and ejectors, which are positioned in the chambers opposite respective orifices. The pulse-jet heads may be any convenient pulse jet including, such as a thermal pulse jet head, a piezoelectric pulse jet head, etc., where these disparate types of pulse jet heads are well known to those of skill in the art. While the following additional description is provided primarily in terms of a thermal pulse-jet head device, piezoelectric devices may be used in certain embodiments and come within the scope of the invention.

In one aspect, each ejector is in the form of an electrical resistor operating as a heating element under control of a processor 50 (although piezoelectric elements could be used instead). Each orifice with its associated ejector and portion of the chamber, defines a corresponding pulse-jet head. Application of a single electric pulse to an ejector will cause a droplet to be dispensed from a corresponding orifice. Certain elements of the heads of head assembly 30 can be adapted from parts of a commercially available thermal inkjet head device, such as available from Hewlett-Packard Co. as part no. HP51645A. Alternatively, multiple heads could be used instead of a single head and being provided with respective transporters under control of processor 140 for independent movement. In this alternative configuration, each head may dispense a corresponding monomer or activator.

The amount of fluid that is expelled in a single activation event of a pulse jet can be controlled by changing one or more of a number of parameters, including the orifice diameter, the orifice length (thickness of the orifice member at the orifice), the size of the deposition chamber, and the size of the heating element, along with others. The amount of fluid that is expelled during a single activation event is generally in the range of about 0.1 pL to 1000 pL, usually about 0.5 to about 500 pL and more usually about 1.0 to about 250 pL. A typical velocity at which fluid is expelled from the chamber is more than about 1 m/s, usually more than about 10 m/s, and may be as great as about 20 m/s or greater. As will be appreciated, if the orifice is in motion with respect to the receiving surface at the time an ejector is activated, the actual site of deposition of the material will not be the location that is at the moment of activation in a line-of-sight relation to the orifice, but will be a location that is predictable for the given distances and velocities.

As mentioned above, the pulse-jet heads of the system depicted in FIG. 5 do not include activator-dispensing heads, but instead include heads that are not operatively connected to a source of fluid activator composition. The pulse-jet heads, configured to deliver monomers, can be activated to deliver a volume of monomer to each feature location as desired and/or according to programmed instructions. Once the pulse-jet head assembly has traveled across the desired length or width of the substrate, the pulse-jet head assembly can be stepped to start a new row. In certain embodiments, the number of pulse jets in a given head is limited to that required for delivery of monomer, and therefore is reduced as compared to heads that are employed in protocols which deposit fluid activator composition from a pulse jet. In certain embodiments, the number of heads may be as little as 4 or a multiple of four (e.g., one for each of the four standard phosphoramidites), such as 8, 12, 16, 20, 24, etc.

The device may further include a display 310 and an operator input device 312. The operator input device may be, for example, a keyboard, mouse, or similar input devices. Processor 140 has access to a memory, and controls the pulse-jet head assembly 210, (specifically the activation of the ejectors therein), operation of the positioning system, operation of each pulse-jet disposed in the pulse-jet head, and operation of the display 310. Memory 326 may be any suitable device in which processor 140 can store and retrieve data 324, such as magnetic, optical, or solid-state storage devices. Processor 140 may include a general purpose digital microprocessor suitably programmed from a computer readable medium carrying necessary programming code, to execute all of the steps required by the present invention, or any hardware or software combination which will perform the equivalent steps. The programming may be provided remotely to processor 140, or previously saved in a computer program product such as memory 326 or some other portable or fixed computer readable medium using any of those devices mentioned above.

Programming for controlling the device according to the present invention is also provided. For example, the programming may control the device to flood the substrate surface with activator fluid, and then remove the fluid from the surface in a manner that results in the production of solid activator in feature locations of the surface, as reviewed above. The programming may further control the pulse-jet head and pulse-jets to form an array according to an input selection from a user, e.g., the user may be presented through a graphical interface multiple choices of types of arrays that may be formed. The user, through an input device, may choose the type of array to be formed, wherein the programming controls the device according to the present invention to form the array selected by the user.

Operation of the device will now be described in accordance with aspects of the method described herein. In one aspect, memory 326 holds instructions for providing a target drive pattern for a target array and which can include, for example, target locations and dimensions for each spot or feature on substrate 10. The instructions can further include, for example, movement commands which can be executed by transporters 60 and 45 as well as firing commands for each of the pulse-jets disposed in head 210 coordinated with the movement of head 210 and substrate 10. In one aspect, this target drive pattern is based upon a desired target array pattern and can have either been input from an appropriate source (such as input device 312, a portable magnetic or optical medium, or from a remote server, any of which may communicate with processor 140), or may have been determined by processor 50 based on an input target array pattern (using any of the appropriate sources previously mentioned) and the previously known operating parameters of the apparatus. The memory holding instructions for providing a target drive pattern can further include instructions to head assembly 210 and positioning system of the device to deposit the activator at each region at which a feature is to be formed. The pulse-jets can be loaded with four different monomers. In one aspect, the flood station 68 is loaded with all necessary solutions, including fluid activator composition. Operation of the following sequences are controlled by processor 140, following initial operator activation, unless a contrary indication appears.

In one embodiment, for any given substrate 10, a substrate 10 is loaded onto the substrate station 20, either manually or automatically. A target drive pattern necessary to obtain a target array pattern, is determined by processor 140 (if not already provided), based on operating parameters of the device. In one aspect, the device is then operated as follows: (a) if not the first cycle, position substrate 10 at flood station 68 and for all regions of the arrays being formed, deprotect previously deposited and linked monomer on substrate 10, as well as solid activator, at flood station 68; (b) move substrate 10 to receive droplets from head assembly 210 and deposit droplet(s) to dispense a volume of appropriate next monomer onto each region, such that the first linking group is activated by the activator and links to previously deprotected monomer; (c) move substrate 10 back to flood station 68 for oxidation, capping and washing steps over entire substrate, as well as additional solid activator deposition, as required; and (d) repeat foregoing cycle for all of the regions of all desired arrays until the desired arrays are completed.

Aspects of the invention include quality control protocols in which one need only inspect whether a phosphoramidite drop has been deposited on a surface at a desired feature location. As such, using the subject methods, one need not determined whether two or more fluid drops have been deposited in the same feature in a suitable aligned fashion. In the quality control protocols employed in embodiments of the invention, one can first look for patterned surface of dried activator following deposition, e.g., as described above, where the features with dried activator present therein should appear different from the interfeature regions that lack activator, e.g., different in grey scale, etc. Then, following deposition of phosphoramidite fluid into a given feature location, one can inspect to ensure that fluid has indeed been deposited in the desired location. This process can then be repeated for each iteration of the protocol. As compared to protocols where the activator is also deposited as a fluid drop onto a feature, one need not inspect and determine whether two drops have been properly deposited. As such, aspects of the invention include methods that include inspecting a surface of a solid support following activator deposition, e.g., as described above, to determine whether solid activator is present in the feature locations; then positioning a pulse jet head over a feature location of the surface and actuating the pulse jet head; and then inspecting the feature to ensure that the actuating caused the pulse jet head to correctly dispense a fluid drop onto the feature location of the surface.

The invention provides substrates having solid activator occupied features separated by interfeature areas of substantially no solid activator. The amount of solid activator present in a given feature may vary, so long as it is sufficient to provide for the desired activation activity, as reviewed above, upon contact with a reagent.

The invention also provides arrays of polymeric binding agents or ligands produced according to the methods described above. The arrays include at least two distinct polymers that differ by monomeric sequence immobilized on, e.g., covalently bonded to, different and known locations on a substrate surface. In certain embodiments, each distinct polymeric sequence of the array is typically present as a composition of multiple copies of the polymer on the substrate surface, e.g., as a spot on the surface of the substrate. The number of distinct polymeric sequences, and hence spots or similar structures, present on the array may vary, but is generally at least 2, usually at least 5 and more usually at least 10, where the number of different spots on the array may be as a high as 50, 100, 500, 1000, 10,000, 25,000 or higher, depending on the intended use of the array. The spots of distinct polymers present on the array surface can be present as a pattern, where the pattern may be in the form of organized rows and columns of spots, e.g., a grid of spots, across the substrate surface, a series of curvilinear rows across the substrate surface, e.g., a series of concentric circles or semi-circles of spots, and the like. The density of spots present on the array surface may vary, and can be at least about 10, such as at least about 100 spots/cm², where the density may be as high as 10⁶ spots/cm² or higher, but in certain embodiments will not exceed about 10⁵ spots/cm².

Because of the manner in which the subject arrays are produced, the product arrays may be high resolution arrays of highly uniform small diameter features. By high resolution is meant that the density of the individual features have a high density. By high density is meant at least about 100 features/cm², such as at least about 500 features/cm², where the density may, in certain embodiments, range from about 500 to about 10,000 or more, such as from about 500 to about 10,000 features/cm². In certain embodiments, the features have diameters that do not exceed about 1000 μm, such as features that do no exceed about 100 μm, and the magnitude of any difference in diameter of any two features on the array does not exceed about 20% of the diameter, such as does not exceed about 5% of the diameter. This high resolution uniform small diameter feature characteristic is achievable using in situ preparation protocols, as described above.

In one aspect, the arrays of the invention are arrays of polymeric binding agents or ligands, where the polymeric binding agents or ligands may be any of: peptides, proteins, nucleic acids, polysaccharides, synthetic mimetics of such biopolymeric binding agents, etc. In representative embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini, e.g., the 3′ or 5′ terminus. In other embodiments, the arrays are arrays of polypeptides, e.g., proteins or fragments thereof.

Chemical arrays produced as described above find use in a variety of different applications, where such applications include analyte detection applications in which the presence of a particular analyte in a given sample is detected at least qualitatively, if not quantitatively, array CGH assays, location analysis assays, nucleic acid synthesis applications, genotyping assays, and the like. Protocols for carrying out such assays are well known to those of skill in the art and need not be described in great detail here. Generally, for analyte detection applications, the sample suspected of comprising the analyte of interest is contacted with an array produced according to the subject methods under conditions sufficient for the analyte to bind to its respective binding pair member that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g. a member of signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; nucleic acid sequencing assays, and the like. Patents and patent applications describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992. Also of interest are U.S. Pat. Nos. 6,656,740; 6,613,893; 6,599,693; 6,589,739; 6,587,579; 6,420,180; 6,387,636; 6,309,875; 6,232,072; 6,221,653; and 6,180,351. In certain embodiments, the subject methods include a step of transmitting data from at least one of the detecting and deriving steps, as described above, to a remote location.

Where the arrays are arrays of polypeptide binding agents, e.g., protein arrays, specific applications of interest include analyte detection/proteomics applications, including those described in U.S. Pat. Nos. 4,591,570; 5,171,695; 5,436,170; 5,486,452; 5,532,128 and 6,197,599 as well as published PCT application Nos. WO 99/39210; WO 00/04832; WO 00/04389; WO 00/04390; WO 00/54046; WO 00/63701; WO 01/14425 and WO 01/40803—the disclosures of which are herein incorporated by reference.

As such, in using an array made by the method of the present invention, the array will typically be exposed to a sample (for example, a fluorescently labeled analyte, e.g., nucleic acid or protein containing sample) and the array then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

In certain embodiments, the methods include a step of transmitting data from at least one of the detecting and deriving steps, as described above, to a remote location. By “remote location” is meant a location other than the location at which the array is present and hybridization occur. For example, a remote location could be another location (e.g., office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart. “Communicating” information means transmitting the data representing that information as signals (e.g., electrical, optical, radio signals, and the like) over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, internet, etc.

As such, in using an array made by the method of the present invention, the array will typically be exposed to a sample (for example, a fluorescently labeled analyte, e.g., nucleic acid- or protein-containing sample) and the array then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER scanner available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934; the disclosures of which are herein incorporated by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

Kits for use in analyte detection assays are also provided. The kits at least include the arrays of the invention. The kits may further include one or more additional components necessary for carrying out an analyte detection assay, such as sample preparation reagents, buffers, labels, and the like. As such, the kits may include one or more containers such as vials or bottles, with each container containing a separate component for the assay, and reagents for carrying out an array assay such as a nucleic acid hybridization assay or the like. The kits may also include a denaturation reagent for denaturing the analyte, buffers such as hybridization buffers, wash mediums, enzyme substrates, reagents for generating a labeled target sample such as a labeled target nucleic acid sample, negative and positive controls and written instructions for using the array assay devices for carrying out an array based assay. The instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette.

The following examples are offered by way of illustration and not by way of limitation.

### EXAMPLES

DNA microarrays were manufactured according to the standard Agilent manufacturing process. An automated tool designed by Agilent Technologies was used in conjunction with standard phosphoramidite chemistry on a silylated 6.625×6 inch wafer according to the following protocol. First, the solid support used was a flat, non-porous surface. Second, the coupling step was controlled in space using inkjet-printing technologies to deliver the appropriate amount of phosphoramidite to the appropriate spatial location on the solid support. Third, the oxidation and detritylation reactions were performed in dedicated flowcells whose mechanical operations are described below. The oxidation solution was 0.02M I₂ in THF/Pyridine/H₂O and the detritylation solution was 3% DCA in Toluene. Finally, the activator for the coupling step was delivered as explained latter.

Oxidation and detritylation reactions were carried out by flood steps in a flowcell. The flowcell was constructed such that a glass substrate carrying the microarray substrate formed one wall of the reactor chamber. The substrate was brought to bear upon a seal embedded in the perimeter of the fixed reactor cell thus forming a high aspect ratio sealed chamber, where the aspect ratio is defined as the ratio of the planar flowcell width L to the lateral gap height h. Active liquid reagents, wash solvents and gases were introduced into the flowcell through two ports. One port was located at the bottom corner of the cell and one at the top. A series of solenoid valves controlled the inflow and outflow of reagents to these two ports. The flowcell was mounted such that the walls of the flowcell were vertical so that gravity assisted draining. During a typical synthesis cycle, the reagents were first introduced in the flowcell from the bottom port until the flowcell was filled (fill time). The reagents were then left in the flowcell without mixing for 30 s for oxidation and 60 sec for detritylation. Finally, the reagents were drained from the bottom port (drain time), followed by washes using 2 flowcell volumes of acetonitrile (ACN). This volume was typically 30 to 50 mL depending on the particular flowcell geometry.

The deposition of the activator reagent for the coupling reaction was performed as follows. For at least one synthesis cycle, and typically for 10 cycles, the activator was delivered spatially using an inkjet process identical to the delivery of phosphoramidite reagents. After these initial cycles, the activator was delivered at the appropriate location using a flowcell. After the end of deblock cycle (deblock followed by ACN washes), a solution of 250 mM of Tetrazol in Toluene was introduced in the flowcell and drained at a speed of 1 cm/s followed by 60 sec under N₂. The wafer was then transferred to the print module for delivery of phosphoramidite by inkjet technology. Similar results were obtained when using 99:1 ACN:Propylene carbonate instead of Toluene as the solvent. A representative image of the effect of draining on a microarray surface a model solution containing a non volatile organic compound in Toluene is shown in FIG. 6.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A method of providing an activator reagent at feature locations on a surface of a solid support, said method comprising:
(a) contacting said surface with a fluid activator composition comprising said activator reagent, wherein:
(i) said surface comprises a plurality of feature locations separated by inter-feature regions that have a different wettability than said feature locations; and
(ii) said contacting occurs in a manner such that said fluid activator composition covers a plurality of said feature locations and any intervening inter-feature regions; and
(b) removing fluid from said fluid activator composition on said surface to produce solid activator at said plurality of feature locations and substantially no activator in said intervening inter-feature regions.

2. The method according to claim 1, wherein said contacting occurs in a manner such that all of said feature locations are covered with said fluid activator composition.

3. The method according to claim 2, wherein said contacting comprises flooding said surface with said fluid activator composition.

4. The method according to claim 1, wherein said removing comprises draining said fluid activator composition from said surface at rate ranging from about 1 mm/s to about 30 cm/s.

5. The method according to claim 4, wherein said method further comprising evaporating solvent from fluid activator composition droplets remaining on said substrate surface after said draining.

6. The method according to claim 1, wherein said fluid activator composition comprises an activator reagent and a low-boiling point solvent.

7. The method according to claim 6, wherein said low-boiling point solvent is acetonitrile.

8. The method according to claim 6, wherein said fluid activator composition comprises at least two different solvents.

9. The method according to claim 1, wherein said method further comprises producing ligands in features on said surface.

10. The method according to claim 9, wherein said method comprises producing at least two different ligands in two different features of said surface.

11. The method according to claim 9, wherein said producing comprises depositing premade ligands onto said surface.

12. The method according to claim 9, wherein said producing comprises depositing ligand precursors onto said surface.

13. The method according to claim 9, wherein said ligands are selected from oligonucleotides, polynucleotides, peptide-nucleic acids and peptides.

14. The method according to claim 13, wherein said polynucleotides are deoxyribonucleic acids.

15. The method according to claim 1, wherein said substrate is glass.

16. A method comprising:
inspecting a surface of a solid support according to claim 1 to determine whether solid activator is present in said feature locations;
positioning a pulse jet head over a feature location of said surface and actuating said pulse jet head; and
inspecting said feature to ensure said actuating caused said pulse jet head to correctly dispense a fluid drop onto said feature location of said surface.

17. A substrate having a surface produced according to the method of claim 1.

18. A chemical array produced according to the method of claim 9.
